(19) United States
(12) Patent Application Publication
(10) Pub. No.: US 2008/0120848 A1
(43) Pub. Date: May 29, 2008

(54) CRAYON SHARPENER

(75) Inventors: Steven Sze Chun FONG, Hong Kong SAR (CN); Kim Ming NG, Hong Kong SAR (CN); Xue Yuan LI, Hong Kong SAR (CN)

Correspondence Address: LEYDIG VOIT & MAYER, LTD, 700 THIRTEENTH ST. NW, SUITE 300, WASHINGTON, DC, 20005-3960, US

(73) Assignee: Choon Nang Electrical Appliance Manufactory Limited, Hong Kong SAR (CN)

(21) Appl. No.: 11/563,057

(22) Filed: Nov. 24, 2006

(51) Int. Cl. B43L 23/00

(52) U.S. Cl. 30/454

(57) ABSTRACT

A blade holder has cutting edges for cutting a frustoconical tip to sharpen a crayon and also for cutting a sleeve wrapping the crayon. Outlet apertures in the blade holder allow the swarf to escape during sharpening. A serrated knife is mounted to the blade holder for circumferentially scoring the sleeve, weakening the cut strip of sleeve or breaking it up to avoid clogging of the outlet apertures. The blade holder includes a coupling by which it may be connected without tools to a mating motor-driven coupling, while ensuring proper axial alignment. A female coupling has an aperture extending between first and second mouth portions in a transverse side and longitudinal end of the first coupling respectively, and joined by a slotted mouth portion. The mating male coupling has a neck terminating in a head at an axial end of the neck. The neck being sized to pass through the slotted mouth portion, and the head being sized to pass transversely through the first mouth portion. Interengagement of drive faces transmits torque between the female and male couplings.

### TECHNICAL FIELD

The invention relates to rotary cutting tools for sharpening the ends of crayons to return them generally to their manufactured form and particularly, but not exclusively, to motor-driven crayon sharpeners.

### BACKGROUND OF THE INVENTION

The conventional crayon or pencil sharpener includes a cutter assembly with a generally conical cavity for receiving the end of the crayon. A cutting edge is typically straight and aligned with the cavity wall, extending axially parallel to a central axis of the cavity and tapered radially inwardly toward the inner end of the cavity for forming a conical or frustoconical face on the tip of the crayon. Outlet apertures in the cavity allow the swarf to escape during sharpening.

U.S. Pat. No. 5,875,555 describes a sharpener which avoids the need to manually remove the paper sleeve from the end of the crayon before sharpening. It includes two additional blades which cooperate to cut a shoulder at the outer end of the conical or frustoconical tip. One blade extends radially for cutting through the sleeve and forming a radially-aligned annular face, while the other blade extends axially for cutting an intersecting face of the shoulder. One of the difficulties is that cutting assemblies of this type can become bound up with swarf. The swarf includes a long strip of paper sleeve which can become wrapped about a rotating cutter assembly and bound firmly in place by the cuttings of wax crayon. If this swarf closes the outlet apertures it must be manually cleared before the sharpener can be used again. Furthermore, clearing the outlet apertures in some motorised crayon sharpeners requires tools and takes considerable time due to the difficulty of accessing the cutter assembly.

It is an object of the present invention to overcome or substantially ameliorate at least one of the above disadvantages or more generally to provide an improved crayon sharpener.

### DISCLOSURE OF THE INVENTION

In one aspect the invention provides a sharpener for crayons wrapped in sleeves, comprising:

a blade holder with a cavity for receiving a tip of the crayon, the cavity having a central longitudinal axis and frustoconical wall portions tapering inwardly from a mouth to an end;
a first blade mounted to the blade holder with a first cutting edge aligned with the cavity wall portions for cutting a frustoconical face on the tip of the crayon;
one or more cutting edges separate from the first cutting edge for cutting the sleeve and forming a shoulder at an inner end of the frustoconical tip, and
a serrated knife mounted for rotation by engagement with the crayon for circumferentially scoring the sleeve.

The strip of sleeve material removed by the second and third blades as the crayon is advanced into the cavity during sharpening is thus scored transversely by the serrated blade, weakening it or breaking it into shorter lengths.

Preferably the one or more cutting edges include:

a second cutting edge formed on a second blade mounted to the blade holder, the second blade projecting substantially transversely into the mouth of the cavity for cutting through the sleeve; and
a third cutting edge formed on a third blade mounted to the blade holder, the third blade extending substantially longitudinally and having an outer end aligned longitudinally with the second blade projecting into the cavity for cooperating with the second blade for cutting the sleeve and forming the shoulder.

The serrated knife preferably projects into the mouth of the cavity and has teeth configured to pierce the sleeve. The blade holder preferably includes a pair of opposing flanges extending substantially radially relative to the longitudinal axis, each of the serrated knife and second blade being mounted to a respective one of the flanges.

Preferably the second blade includes an arcuate cutting edge. The first and third blades are preferably mounted on opposing sides on a substantially longitudinally extending body portion of the blade holder.

In another aspect there is provided a motor-driven crayon sharpener, comprising:

a blade holder with a cavity for receiving a tip of the crayon, the cavity having a central longitudinal axis and frustoconical wall portions tapering inwardly from a mouth to an end;
a first blade mounted to the blade holder with a first cutting edge aligned with the cavity wall portions for cutting a frustoconical face on the tip of the crayon;
one or more cutting edges separate from the first cutting edge for cutting the sleeve and forming a shoulder at an inner end of the frustoconical tip;
a motor drive;
a rotary output driven by the motor drive for rotation about the axis, the rotary output including one of a first and second coupling;
wherein the blade holder includes the other of the first and second coupling for releasably connecting the blade holder to the rotary output;
the first coupling having an aperture extending between first and second mouth portions formed in a transverse side and longitudinal end of the first coupling respectively, the first and second mouth portions being joined by a slotted mouth portion,
the second coupling having a neck terminating in a head at an axial end thereof, the neck being sized to pass through the slotted mouth portion, and the head being sized to pass transversely through the first mouth portion,
each coupling having a drive face, whereby interengagement of the drive faces permits the transmission of torque between the couplings,
each coupling having a cylindrical face, whereby interengagement of the cylindrical faces maintains axial alignment between the couplings, and
a latch fixed to the first coupling for engaging the second coupling in a latched position to prevent the head from escaping from the first mouth portion.

The first coupling is preferably provided on one end of the blade holder and an axially opposing end of the blade holder includes an axially-extending cylindrical spigot, the sharpener including a journal recess axially aligned with the cylindrical faces of the second coupling for receiving the spigot.

Preferably the head includes said cylindrical face and said drive face. Most preferably two substantially parallel and planar drive faces are provided on opposing sides of the head.

Preferably a recess in the cylindrical face of the head extends through a longitudinal end surface of the head, the latch has a tab which projects into the aperture in the first coupling, in an unlatched position the tab being received in the recess and in the latched position the tab abutting the longitudinal end surface of the head to prevent the head from escaping from the first mouth portion.

The latch is slidably received in a transversely-extending aperture in the latch-receiving portion of the first coupling.

The latch has a length exceeding the transverse dimension of the latch-receiving portion.

Preferably the first coupling includes a thumbwheel flange through which the slotted portion extends substantially radially. Preferably the slotted portion has opposing edges aligned substantially parallel with the drive faces of the first coupling.

This invention provides a crayon sharpener which is effective and efficient in operational use, and which may be economically manufactured. The provision of a scoring knife according to the invention significantly reduces instances of swarf binding the outlet apertures in the cutter. Should it become necessary to clear the cutter, the blade holder can be readily removed without the need for tools, allowing good access for clearing it.

### BRIEF DESCRIPTION OF THE DRAWINGS

Preferred forms of the present invention will now be described by way of example with reference to the accompanying drawings, wherein:

FIG. 1a is a side view of a blade holder of a crayon sharpener of the invention;

FIG. 1b is a first end view of the blade holder of FIG. 1a;

FIG. 1c is section AA from FIG. 1b;

FIG. 1d is a second end view of the blade holder of FIG. 1a;

FIGS. 1e and 1f are pictorial views of the blade holder of FIG. 1a;

FIG. 2 is a side view of a crayon sharpened using the crayon sharpener of the invention;

FIG. 3 is a section in an upright central plane of a crayon sharpener of the invention in use;

FIG. 4a is an end view of a female coupling of the sharpener of FIG. 3;

FIG. 4b is section BB from FIG. 4a, and

FIG. 5a-5d are schematic sections showing successive stages in coupling the blade holder to the sharpener.

### DESCRIPTION OF THE PREFERRED EMBODIMENTS

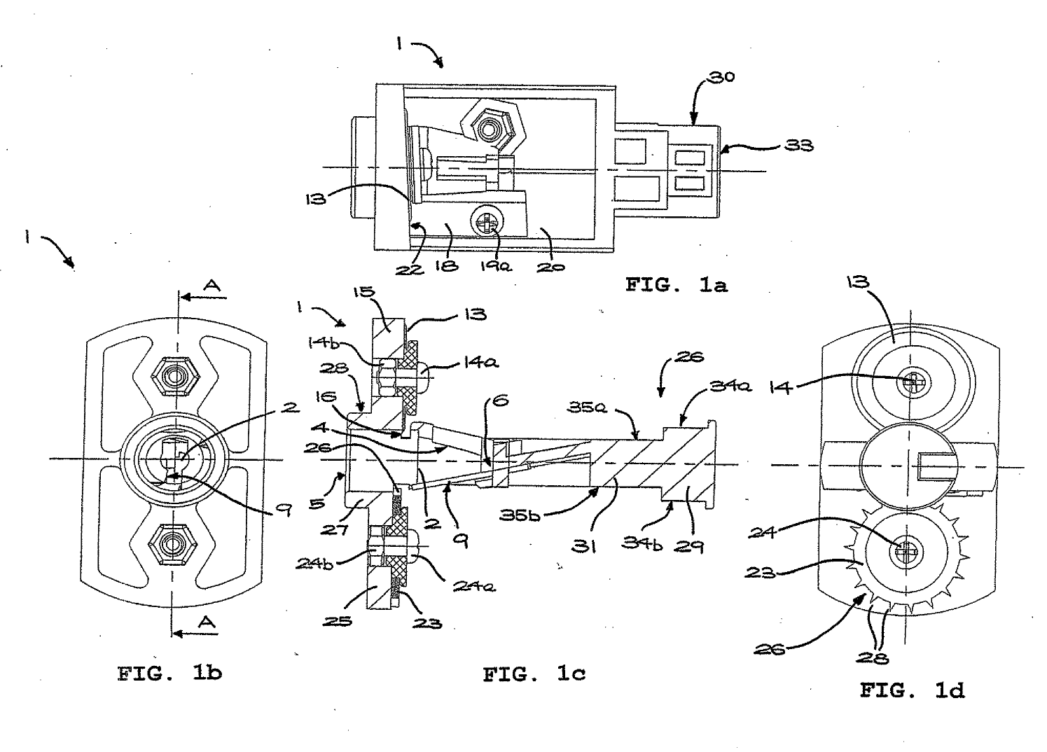

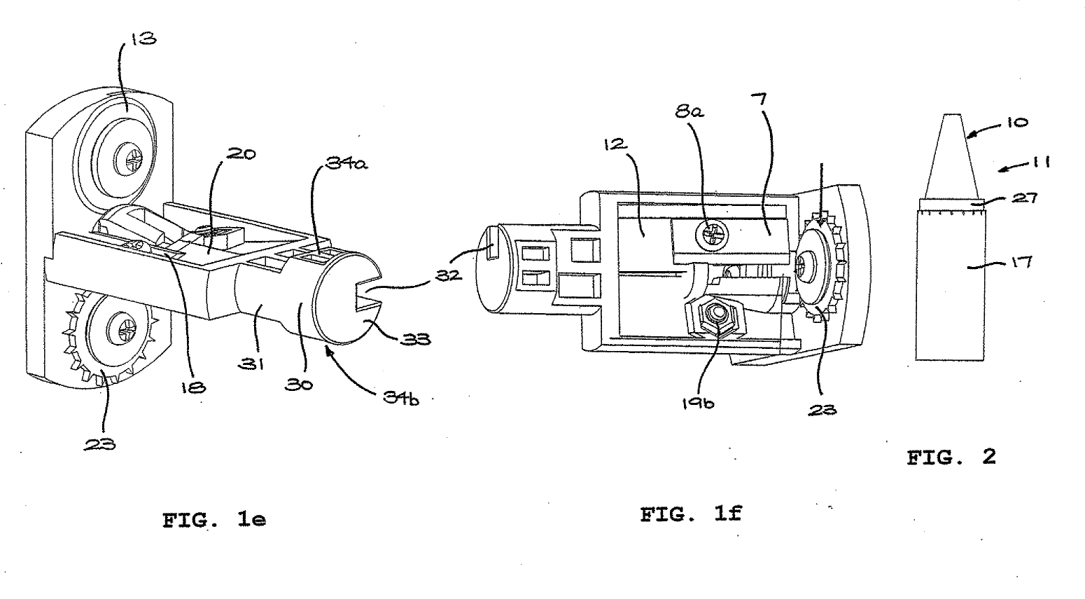

Referring to the drawings, particularly FIGS. 1a-1f, a crayon sharpener includes a moulded plastic blade holder 1 having a pair of flanges 15, 25 extending from opposing sides of an outer end of the central body 26 forming a T-shape. A cavity 2 is formed in the outer end for receiving the tip 11 of the crayon. The cavity 2 has a central longitudinal axis 3 and frustoconical wall portions 4 tapering inwardly from a mouth 5 to a planar end 6.

A first rectangular blade 7 is fixed by a screw 14a and nut 8b against a planar face 12 inclined acutely to the axis 3. The first blade 7 has a linear first cutting edge 9 aligned parallel with the cavity wall portions 4 for cutting at least a frustoconical face 10 on the tip 11. Alternatively the tip 11 may have a conical shape.

A second disc-shaped blade 13 is mounted by a screw 14a and nut 14b against the radially-aligned flange 15 such that a portion of its circular cutting edge 16 projects transversely into the mouth 5 of the cavity 2. In use the edge 16 cuts radially through the paper sleeve 17.

A third rectangular blade 18 is fixed by a screw 19a and nut 19b against a planar face 20 such that the outer edge 22 of the third blade 18 is aligned longitudinally with the second blade 13. In use the third blade 18 cooperates with the second blade 13 to cut the sleeve. The blades 13 and 18 cut generally square-edged shoulder 27 at the outer end of the frustoconical tip 11. The second blade 13 forms a radially-aligned annular face of the shoulder while the blade 18 forms an intersecting cylindrical face of the shoulder 27, the blades 13, 18 removing a strip of sleeve as the crayon is advanced through the sharpener.

A serrated knife 23 is mounted for rotation about a screw 24a and nut 24b which holds the knife 23 against a radially-aligned flange 25 such that a portion of its serrated cutting edge 26 projects transversely into the mouth 5 of the cavity 2. The circular cutting edge 26 includes relatively slender pointed teeth 28 for scoring the sleeve 17. The teeth 28 are sufficient long and project sufficiently into the cavity 2 to pierce the sleeve 17 while also providing engagement such that relative rotated of the crayon rotates the knife 23. The strip of sleeve material removed by the second and third blades 13, 18 as the crayon is advanced into the cavity during sharpening is thus scored transversely by the teeth 28, weakening it or breaking it into shorter lengths which on a motorised sharpener avoids the strips becoming wrapped about a rotating cutter assembly.

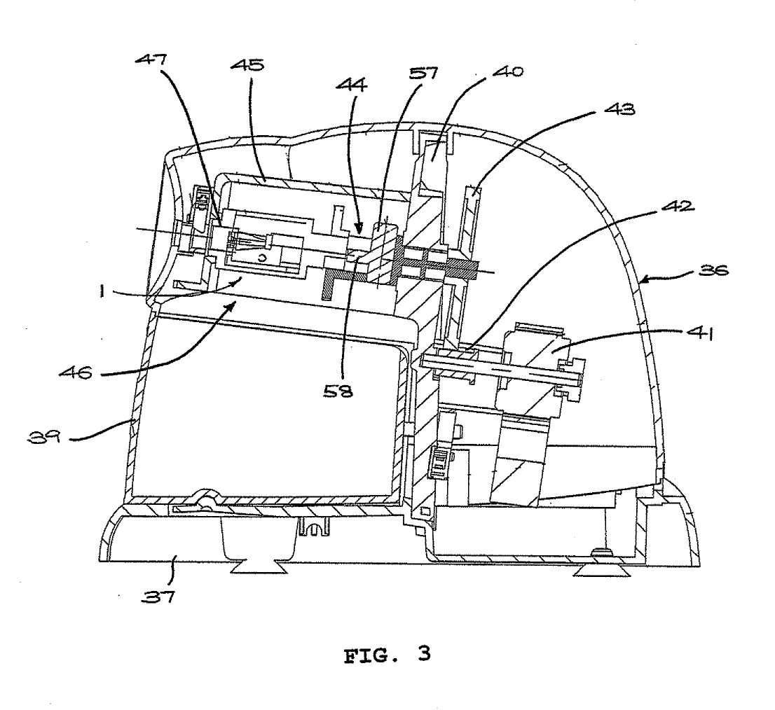

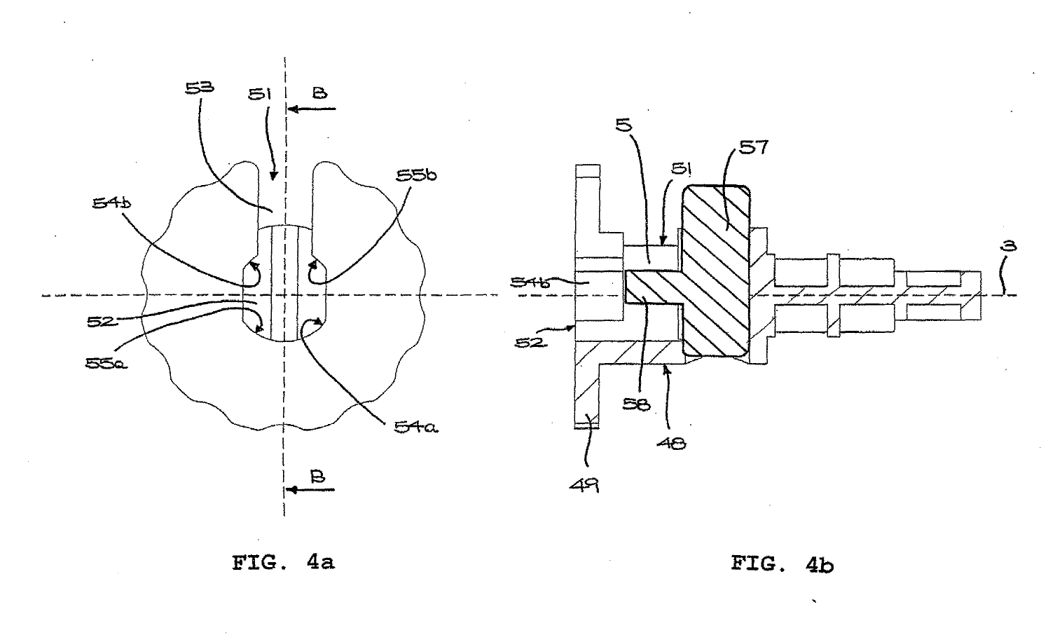

As best seen in FIG. 3 the motorised crayon sharpener includes a one-piece housing 36 mounted upon a base 37. An opening 38 in the housing is provided for receiving the tip 11 of the crayon. The blade holder 1 is mounted in the housing 36 above a removable swarf drawer 39 supported upon the base 37. A mounting plate 40 extends uprightly in a central part of the housing 36 and supports an electric motor 41 to which a pinion 42 is fixed for driving a gear 43. The gear 43 is connected to rotate with a female coupling 44 on the other side of the plate 40. A cutter enclosure 45 fixed to the plate 40 has an aperture 46 opening into the drawer 39. A journal recess 47 is formed in the cutter enclosure 45 opposite the female coupling 44 and coaxial with the drive axis 3 thereof.

Projecting outwardly from the flanges 15, 25 is an annular spigot 27 forming a protruding lip concentrically about the mouth 5 and having an outer cylindrical outer face 28. At the opposite end of the blade holder 1 the body 26 includes a neck 31 joined to a coupling head 29. The coupling head 29 has a cylindrical face 30 coaxial with the face 28. A recess 32 in the cylindrical face 30 extends through the end surface 33. On opposing sides of the head 29 are parallel planar drive faces 34a, 34b, positioned axially adjacent parallel planar neck faces 35a, 35b.

The female coupling 44 has a body comprising a cylindrical portion 48 and thumbwheel flange 49. An aperture 50 in the in the female coupling 44 is provided for receiving the coupling head 29, and extends between a first mouth portion 51 in a transverse side and a second mouth portion 52 in a longitudinal end of the female coupling 44. The first mouth portion 51 and second mouth portion 52 are joined by a slotted mouth portion 53. The second mouth portion 52 has opposing planar drive faces 54a, 54b and cylindrical faces 55a, 55b having a spacing and diameter respectively corresponding to those of the faces 34a, 34b and cylindrical face 30 respectively. The width of the slotted mouth portion 53 through the thumbwheel flange 49 corresponds to the spacing between the neck faces 35a, 35b for slidably receiving the neck 31 therebetween.

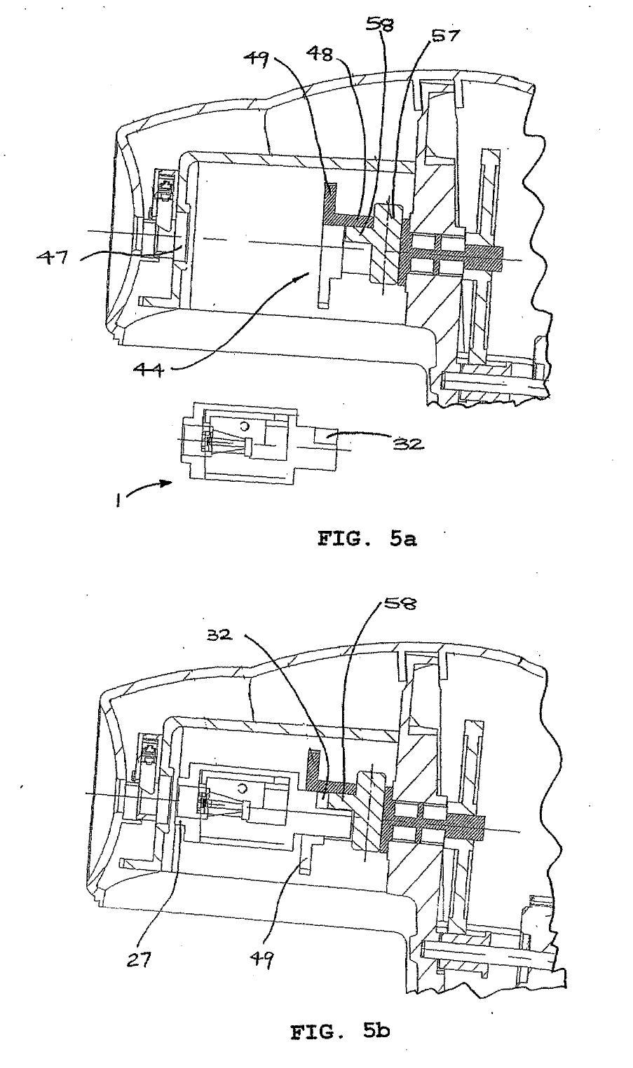

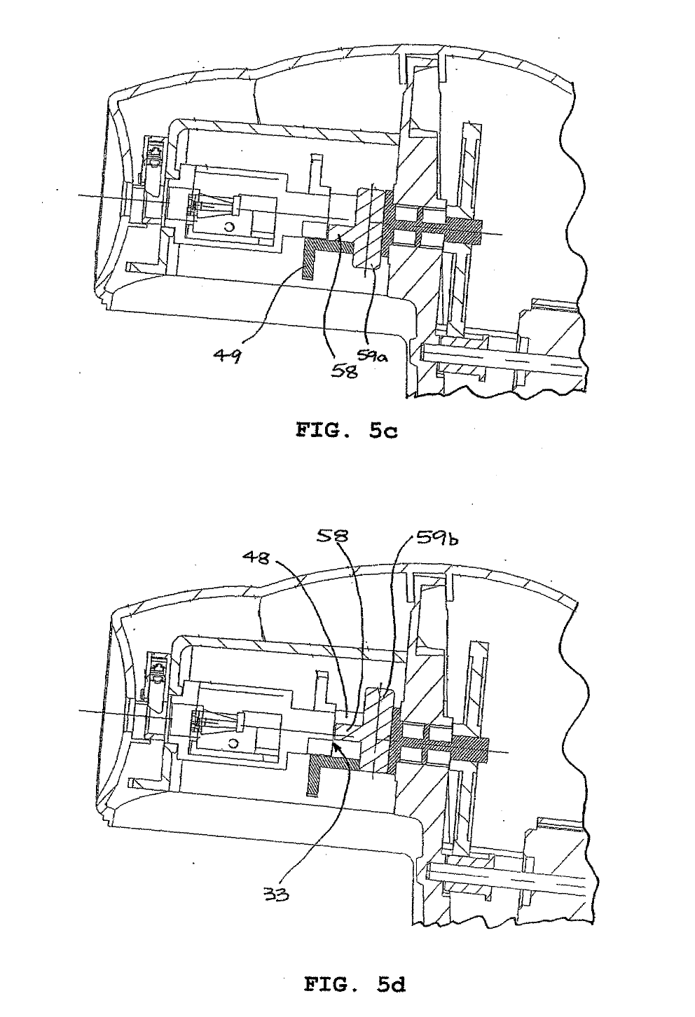

A latch 57 has a tab 58 which projects into the aperture 50. The latch 57 is received in a radially-extending aperture to slide between the positions shown in FIG. 5c and FIG. 5d. The latch 57 has a length exceeding the transverse dimension of the cylindrical portion 48 such that at least one of the opposite outer ends protrudes from the cylindrical portion 48.

In use, with the drawer 39 removed the blade holder 1 is passed through the aperture 46 into the enclosure 45, with the coupling head 29 presented toward the female coupling 44, such that the recess 32 is facing inwardly, as shown in FIG. 5a. The neck 31 is then entered into the slotted mouth portion 53 in the transverse direction, the neck faces 35a, 35b engaging the edges of the portion 53 in a sliding fit which serves to align respective pairs of drive faces 34a, 34b, 54a, 54b. The head 29 then enters through the first mouth 51 and continued transverse movement brings the cylindrical face 30 into abutment with cylindrical face 55a, to the position shown in FIG. 5b. The blade holder 1 is then moved axially to direct the spigot 27 into the journal recess 47. This same axial movement brings the respective pairs of drive faces 34a, 34b, 54a, 54b into mutual engagement, while the faces 55a, 55b cooperate with the face 30 to maintain axial alignment.

Thereafter the latch 57 is actuated to hold the blade holder 1 in position. The user rotates the thumb wheel 49 approximately a half turn to the position illustrated in FIG. 5c, and then presses the protruding end 59a of the latch 57 inwardly. In this position, shown in FIG. 5d; the opposing end 59b protrudes from the cylindrical portion 48. The tab 58 abuts the end face 33 of the head 29 preventing axial movement which might allow the head 29 to escape from the first mouth portion 51. The blade holder 1 is readily removed by pressing end 59b to release the latch and performing the other steps in the reverse order.

Aspects of the present invention have been described by way of example only and it should be appreciated that modifications and additions may be made thereto without departing from the scope thereof.

1. A sharpener for a crayon wrapped in a sleeve, comprising:
a blade holder with a cavity for receiving a tip of the crayon, the cavity having a central longitudinal axis and frustoconical wall portions tapering inwardly from a mouth to an end;
a first blade mounted to the blade holder with a first cutting edge aligned with the wall portions for cutting a frustoconical face on the tip of the crayon;
one or more cutting edges separate from the first cutting edge for cutting the sleeve and forming a shoulder at an inner end of the frustoconical face, and
a serrated knife mounted for rotation by engagement with the crayon for circumferentially scoring the sleeve.

2. The sharpener of claim 1 wherein said one or more cutting edges include:
a second cutting edge formed on a second blade mounted to the blade holder, the second blade projecting substantially transversely into the mouth of the cavity for cutting through the sleeve; and
a third cutting edge on a third blade mounted to the blade holder, the third blade extending substantially longitudinally and having an outer end aligned longitudinally with the second blade projecting into the cavity for cooperating with the second blade for cutting the sleeve and forming the shoulder.

3. The sharpener of claim 1 wherein the serrated knife projects into the mouth of the cavity and has teeth configured to pierce the sleeve.

4. The sharpener of claim 1 wherein the blade holder includes a pair of opposing flanges extending substantially radially relative to the longitudinal axis, each of the serrated knife and second blade being mounted to a respective one of the flanges.

5. The sharpener of claim wherein the second cutting edge is arcuate.

6. The sharpener of claim 2 wherein the first and third blades are mounted on opposing sides on a substantially longitudinally extending body portion of the blade holder.

7. The sharpener of claim 1 further comprising:
a motor drive;
a rotary output driven by the motor drive for rotation about the axis, the rotary output including one of a first coupling and a second coupling, wherein
the blade holder includes the other of the first coupling and the second coupling for releasably connecting the blade holder to the rotary output;
the first coupling has an aperture extending between first and second mouth portions in a transverse side and longitudinal end of the first coupling, respectively, the first and second mouth portions being joined by a slotted mouth portion,
the second coupling has a neck terminating in a head at an axial end of the neck, the neck being sized to pass through the slotted mouth portion, and the head being sized to pass transversely through the first mouth portion,
each of the first and second coupling has a drive face, whereby interengagement of the drive faces transmits torque between the first and second couplings, and
each of the first and second couplings has a cylindrical face, whereby interengagement of the cylindrical faces maintains axial alignment between the first and second couplings; and
a latch fixed to the first coupling for engaging the second coupling in a latched position to prevent the head from escaping from the first mouth portion.

8. A crayon sharpener, comprising:
a blade holder with a cavity for receiving a tip of the crayon, the cavity having a central longitudinal axis and frustoconical wall portions tapering inwardly from a mouth to an end;
a first blade mounted to the blade holder with a first cutting edge aligned with the wall portions for cutting a frustoconical face on the tip of the crayon;
one or more cutting edges separate from the first cutting edge for cutting the sleeve and forming a shoulder at an inner end of the frustoconical face;
a motor drive;
a rotary output driven by the motor drive for rotation about the axis, the rotary output including one of a first coupling and a second coupling, wherein
the blade holder includes the other of the first coupling and the second coupling for releasably connecting the blade holder to the rotary output;
the first coupling has an aperture extending between first and second mouth portions in a transverse side and longitudinal end of the first coupling, respectively, the first and second mouth portions being joined by a slotted mouth portion,
the second coupling has a neck terminating in a head at an axial end of the neck, the neck being sized to pass through the slotted mouth portion, and the head being sized to pass transversely through the first mouth portion,
each of the first and second couplings has a drive face, whereby interengagement of the drive faces transmits torque between the first and second couplings, and
each of the first and second couplings has a cylindrical face, whereby interengagement of the cylindrical faces maintains axial alignment between the first and second couplings; and
a latch fixed to the first coupling for engaging the second coupling in a latched position to prevent the head from escaping from the first mouth portion.

9. The sharpener of claim 7 wherein the first coupling is provided on one end of the blade holder and an axially opposing end of the blade holder includes an axially-extending cylindrical spigot, the sharpener including a journal recess axially aligned with the cylindrical faces of the second coupling for receiving the spigot.

10. The sharpener of claim 7 wherein the head includes the cylindrical face and said drive face.

11. The sharpener of claim 9 including two substantially parallel and planar drive faces located on opposing sides of the head.

12. The sharpener of claim 10 wherein a recess in the cylindrical face of the head extends through a longitudinal end surface of the head, the latch has a tab which projects into the aperture in the first coupling, in an unlatched position, the tab being received in the recess, and, in the latched position, the tab abutting the longitudinal end surface of the head to prevent the head from escaping from the first mouth portion.

13. The sharpener of claim 7 wherein the latch is slidably received in a transversely-extending aperture in a latch-receiving portion of the first coupling, the latch-receiving protion having a transverse dimension.

14. The sharpener of claim 12 wherein the latch has a length exceeding the transverse dimension of the latch-receiving portion.

15. The sharpener of claim 7 wherein the first coupling includes a thumbwheel flange through which the slotted mouth portion extends substantially radially.

16. The sharpener of claim 14 wherein the slotted mouth portion has opposing edges aligned substantially parallel with the drive faces of the first coupling.
